(19) United States
(12) Patent Application Publication
(10) Pub. No.: US 2012/0025550 A1
(43) Pub. Date: Feb. 2, 2012

(54) SUPPORTING ELEMENT FOR BOARDS, PANELS OR THE LIKE

(76) Inventor: Jose Manuel Gonzalez Sanchez, Alicante (ES)

(21) Appl. No.: 13/262,503

(22) PCT Filed: Dec. 22, 2009
(86) PCT No.: PCT/ES09/70618

§ 371 Date: Sep. 30, 2011

(30) Foreign Application Priority Data
Mar. 31, 2009 (ES) U200900644

(51) Int. Cl. B65G 7/12

(52) U.S. Cl. 294/15

(57) ABSTRACT

Supporting element for boards, panels and the like. The support of the invention is suitable for handling flat pieces of large size and for carrying them from one place to another, and to that end has a main body, formed by an inclined handle located in a plane different from that of the rest of the support, and an elongated section from which extends at least one pair of parallel bars for receiving the board to be transported.

### PURPOSE OF THE INVENTION

The present invention relates to the field of tools and workshop equipment, more specifically to devices for supporting and transporting boards, panels or similar.

The main purpose of the present invention is a supporting element for the transport of boards or other flat structures such as windows, doors, etc. of all types of materials (wood, marble, glass, plasterboard, fibreboard, methylacrylates, etc.) between two people.

### BACKGROUND OF THE INVENTION

It is common practice in workshops and in general construction to carry boards, panels or similar objects in a fully manual way using only the hands, with the consequent risk to operatives, who may be cut or harmed, and to the transported object, which may be damaged. Boards are generally carried by two people, one on either side of the object, one of whom faces the direction of movement while the other faces in the opposite direction, walking backwards, giving rise to a risk that is the cause of many accidents.

Current devices for supporting boards or panels do not maintain the vertical orientation of the transported objects so that operatives must use both hands, one for the support and the other for the transported object. These devices are also based on complex systems with high financial cost.

### DESCRIPTION OF THE INVENTION

The previously listed drawbacks are resolved by means of the supporting element for boards, panels or similar objects, the purpose of the invention. The device of the invention constitutes a simple and very useful tool, with a lower cost than current devices for transporting boards.

The present invention refers to a supporting element for transporting boards, which constitutes an auxiliary accessory of particular application in construction workshops. It is suitable for handling flat items of large size and of carrying them from one place to another, maintaining them in a vertical orientation and leaving the operatives with a free hand.

The support comprises a main body, of a size that is suitable for being gripped with one hand at the top end, formed by an inclined handle arranged in a different plane to that of the rest of the support, and an elongated section, from which at least one pair of parallel bars extends, designed to receive the board to be transported.

The elongated section preferably presents two pairs of cylindrical bars of the same material welded to it. These are preferably at right angles to the elongated section, arranged in opposing collinear pairs and located in the middle of it.

In a preferred embodiment of the invention, the handle takes the form of an open curve and has a sleeve on the handle for providing a better grip and another sleeve at the lower end of the elongated section to prevent the object being transported from slipping, from being damaged and scratched.

In a second preferred embodiment, the handle is triangular in shape and convex, linked by the lower vertex to the elongated section, from which the bars extend.

The bars are preferably covered by sleeves, performing the dual function of preventing the piece being transported from slipping and of protecting the piece from scratches and damage that it might suffer by contact. Said sleeves are preferably made of rubber, foam rubber or similar.

Carrying, preferably performed by two people, one at each end of the board and on opposite sides of the board, is achieved by catching hold of the board between two of the bars located in the elongated section and applying sufficient pressure on the board, which remains firmly fixed and ready to be lifted.

The main advantages of the solution of the present invention are simplicity, low financial cost and that the two people using it can move in the same direction, thereby preventing many accidents, leaving one of each of the operators' hands always free.

### DESCRIPTION OF THE FIGURES

In order to complement the description and with the aim of providing better understanding of the characteristics of the invention, in accordance with preferred examples of its practical application, a set of figures is attached as an integral part of the description. The set of figures, which are only for the purposes of illustration and not limiting of the invention, show the following:

FIG. 1. A general view of the supporting element in accordance with a preferred embodiment of the invention.

FIG. 2. A general view of the supporting element with a sleeve on the handle and another on the lower end of the elongated section.

FIG. 3. A general view showing a board being transported by two people with a supporting element on each side.

FIG. 4. The supporting element for boards in accordance with another preferred embodiment of the invention with sleeves on the bars.

### PREFERRED EMBODIMENT OF THE INVENTION

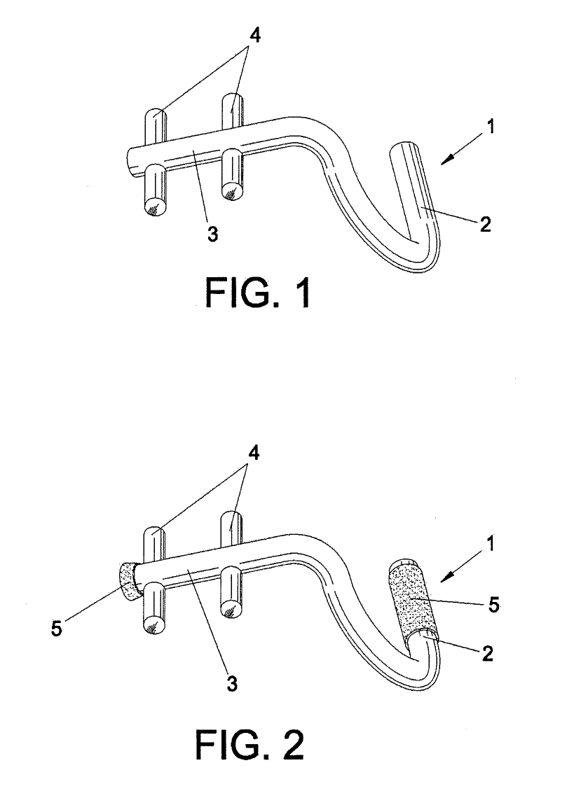

As shown in FIG. 1, the supporting element of the invention is composed of a main body (1), formed by a handle (2), inclined and located in a plane different from the rest of the supporting element, and an elongated section (3) from which at least one pair of parallel bars (4) extend, for receiving the board (6) to be transported.

As shown in the same figure, the bars (4) are cylindrical, welded to the elongated section (3) and of the same material, being preferably perpendicular to the elongated section (3), arranged in opposing collinear pairs and located in the middle of it.

In a preferred embodiment of the invention, shown in FIG. 2, the handle (2) takes the form of an open curve, and has a sleeve (5) to provide a better grip to the supporting element and another at the lower end of the elongated section (3), to prevent the object being transported from slipping, from being damaged and scratched.

In a second preferred embodiment, shown in FIG. 4, the handle (2) is triangular and convex, linked by its lower vertex to the elongated section (3) from which the bars (4) extend.

The bars (4) are preferably covered with sleeves (5), performing the dual function of preventing slipping of the piece to be transported and of protecting it from scratches and damage that it might suffer through contact with the bars (4). These sleeves (5) are preferably made of rubber, foam rubber or similar.

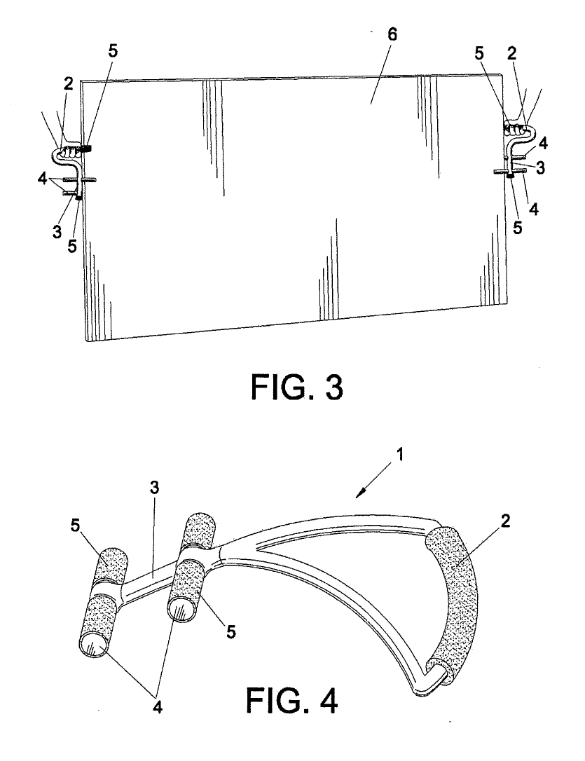

Carrying, preferably performed by two people, one at each end of the board (6) and on opposite sides of the board, as shown in FIG. 3, is achieved by catching hold of the board between two of the bars (4) located in the elongated section (3) and applying sufficient pressure on the board (6), which remains firmly fixed and ready to be lifted.

1. Supporting element for boards, panels or the like, suitable for handling flat pieces of large size, and for carrying them from one place to another, comprising a main body, formed by a handle, inclined and situated in a different plane from that of the rest of the support, and an elongated section from which a pair of parallel bars extend for receiving the board to be transported.

2. Supporting element for boards, panels and the like in accordance with claim 1, wherein the bars extend perpendicularly from the elongated section.

3. Supporting element for boards, panels and the like in accordance with claim 1, comprising two pairs of bars.

4. Supporting element for boards, panels and the like in accordance with claim 3, wherein the two pairs of bars are collinear.

5. Supporting element for boards, panels and the like in accordance with claim 1, characterised in that the bars are cylindrical.

6. Supporting element for boards, panels and the like in accordance with claim 1, wherein the handle is in the form of an open curve.

7. Supporting element for boards, panels and the like in accordance with claim 1, wherein the handle is triangular and convex, linked by the lower vertex to the elongated section.

8. Supporting element for boards, panels and the like in accordance with claim 1, wherein the handle and/or the bars and/or the bottom of the elongated section are covered by a sleeve.

9. Supporting element for boards, panels and the like in accordance with claim 8, wherein the sleeve is made of rubber, foam rubber or similar.
